(19) United States
(12) Patent Application Publication
(10) Pub. No.: US 2022/0029296 A1
(43) Pub. Date: Jan. 27, 2022

(54) ANTENNA AND COMMUNICATION DEVICE

(71) Applicant: JAPAN AVIATION ELECTRONICS INDUSTRY, LIMITED, Shibuya-ku, Tokyo (JP)

(72) Inventors: Keishi KOSAKA, Tokyo (JP); Hiroshi TOYAO, Tokyo (JP); Eiji HANKUI, Tokyo (JP); Yasuhiko MATSUNAGA, Tokyo (JP)

(73) Assignee: JAPAN AVIATION ELECTRONICS INDUSTRY, LIMITED, Shibuya-ku, Tokyo (JP)

(21) Appl. No.: 17/298,288

(22) PCT Filed: Dec. 6, 2019
(86) PCT No.: PCT/JP2019/047901

§ 371 Date: May 28, 2021

(51) Int. Cl. H01Q 9/04

(52) U.S. Cl. CPC H01Q 9/0457

(57) ABSTRACT

An antenna includes a conductor plate, for example. The conductor plate has a slot and a branch slot, wherein the branch slot has one end connected to the slot and another end which, when viewed from the one end, extends along the slot in an antinode direction of an electric field at the lowest-order resonant frequency of the antenna, and is closed in the conductor plate.

### TECHNICAL FIELD

The present invention relates to an antenna and a communication device, for example.

### BACKGROUND ART

A slot antenna is known as an antenna used in a radio communication device.

For example, a slot antenna is disclosed in Patent Document 1.

### PRIOR ART DOCUMENTS

### Patent Document(s)

Patent Document 1: U.S. Pat. No. 9,166,300 Specification

### SUMMARY OF INVENTION

### Technical Problem

For example, the slot antenna in Patent Document 1 is small but has a problem that there is a case where impedance matching cannot be achieved at a plurality of resonance frequencies.

### Solution to Problem

An antenna according to an aspect of the present disclosure may be, for example, an antenna which comprises a conductor plate, wherein: the conductor plate has a slot and a branch slot; the branch slot has one end connected to the slot; and the other end of the branch slot extends along the slot, in a direction toward an antinode of an electric field at a lowest-order resonant frequency of the antenna when viewed from the one end, and is shorted in the conductor plate.

A communication device according to an aspect of the present disclosure may be a communication device which comprises an antenna according to an aspect of the present disclosure.

### Advantageous Effects of Invention

According to various aspects in the present disclosure, for example, a small antenna and a communication device provided with the antenna can be provided, wherein the antenna can achieve impedance matching at a plurality of resonance frequencies.

### BRIEF DESCRIPTION OF DRAWINGS

FIG. 1 shows an example of an antenna according to an aspect of the present disclosure.

FIG. 2 shows an example of an antenna according to an aspect of the present disclosure.

FIG. 3 shows an example of an antenna according to an aspect of the present disclosure.

FIG. 4 shows an example of an antenna according to an aspect of the present disclosure.

FIG. 5 shows an example of an antenna according to an aspect of the present disclosure.

FIG. 6 shows an example of an antenna according to an aspect of the present disclosure.

FIG. 7 shows an example of an antenna according to an aspect of the present disclosure.

FIG. 8 shows an example of an antenna according to an aspect of the present disclosure.

FIG. 9 shows an example of an antenna.

FIG. 10 shows an example of an antenna.

FIG. 11 shows an example of an antenna.

FIG. 12 shows an example of characteristics of an antenna.

FIG. 13 shows an example of characteristics of an antenna according to an aspect of the present disclosure.

FIG. 14 shows an example of an antenna according to an aspect of the present disclosure.

FIG. 15 shows an example of an antenna according to an aspect of the present disclosure.

FIG. 16 shows an example of an antenna according to an aspect of the present disclosure.

FIG. 17 shows an example of an antenna according to an aspect of the present disclosure.

FIG. 18 shows an example of an antenna according to an aspect of the present disclosure.

FIG. 19 shows an example of an antenna according to an aspect of the present disclosure.

FIG. 20 shows an example of an antenna according to an aspect of the present disclosure (front side and back side).

FIG. 21 shows an example of an antenna according to an aspect of the present disclosure.

FIG. 22 shows an example of an antenna according to an aspect of the present disclosure.

FIG. 23 shows an example of an antenna according to an aspect of the present disclosure (front side and back side).

FIG. 24 shows an example of an antenna according to an aspect of the present disclosure (front side and back side).

FIG. 25 shows an example of an antenna according to an aspect of the present disclosure.

FIG. 26 shows an example of an antenna according to an aspect of the present disclosure.

FIG. 27 shows an example of an antenna according to an aspect of the present disclosure.

### DESCRIPTION OF EMBODIMENTS

All aspects in the present disclosure are merely exemplary and are not intended to exclude other examples from the present disclosure or to limit the technical scope of the invention described in the claims.

There may be a case where the description may be omitted in part about combinations of aspects in the present disclosure. The omission is intended to simplify the description but not intended to exclude the combinations from the present disclosure nor limit the technical scope of the inventions described in claims. Regardless of whether the omission is made or not, all combinations of the aspects in the present disclosure explicitly, implicitly, or intrinsically included in the present disclosure. In other words, regardless of whether the omission is made or not, all combinations of the aspects in the present disclosure can be derived from the present disclosure directly and clearly.

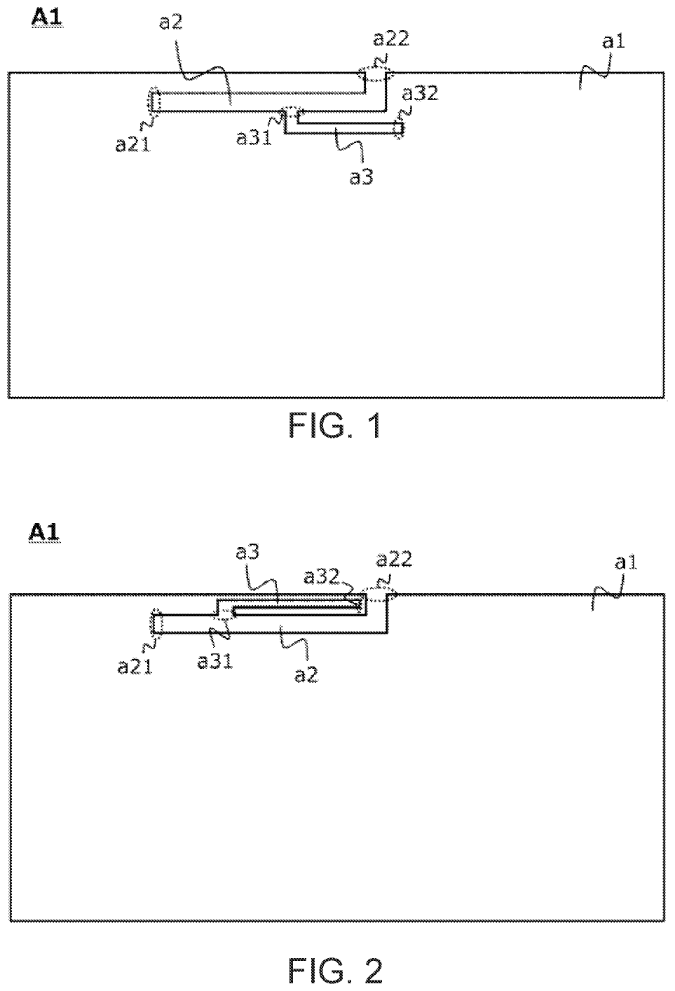

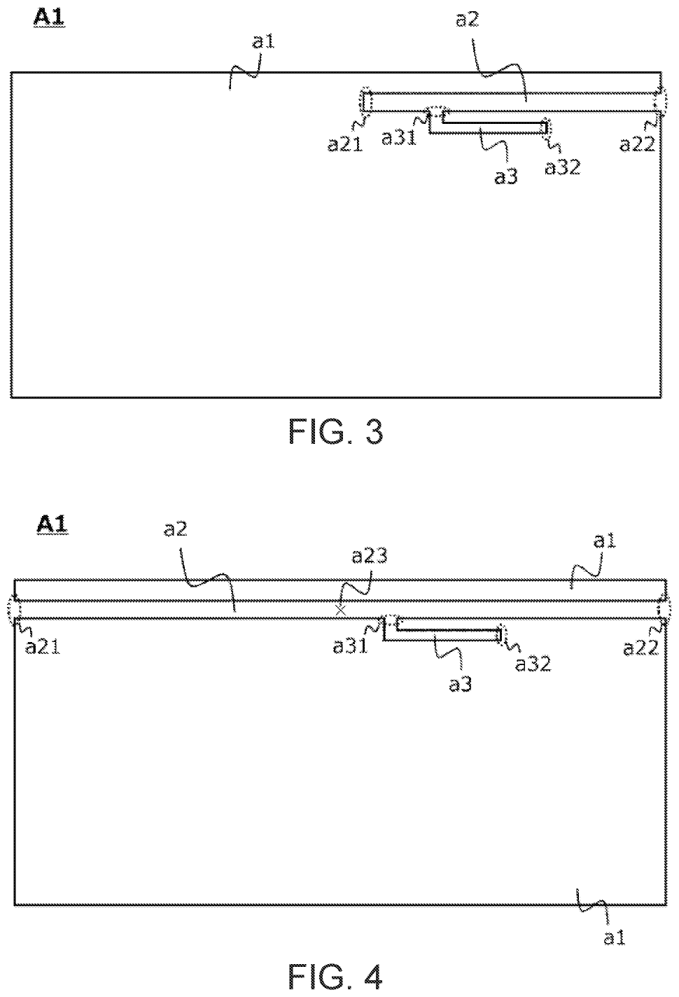

For example, as shown in each of FIGS. 1-8, an antenna according to an aspect of the present disclosure may be an antenna A1 which is provided with a conductive plate a1, wherein: the conductive plate a1 is provided with a slot a2 and a branch slot a3; and the branch slot a3 has one end a31 coupled to the slot a2 and another end a32 extending along the slot a2, in a direction toward an antinode of an electric field at the lowest-order resonance frequency of the antenna A1 when viewed from the end a31, and shorted in the conductive plate a1.

For example, as shown in each of FIGS. 1, 2, 3, 6, 7 and 8, an antenna according to an aspect of the present disclosure may be an antenna A1 which is provided with a conductive plate a1, wherein: the conductive plate a1 is provided with a slot a2 and a branch slot a3; the slot a2 has one end a21 shorted in the conductive plate a1 and another end a22 opened at an edge of the conductive plate; and the branch slot a3 has one end a31 coupled to the slot a2 and another end a32 extending along the slot a2, in a direction toward the other end a22 of the slot a2 when viewed from the end a31 of the branch slot a3, and shorted in the conductive plate a1.

For example, as shown in FIG. 4, an antenna according to an aspect of the present disclosure may be an antenna A1 which is provided with a conductive plate a1, wherein: the conductive plate a1 is provided with a slot a2 and a branch slot a3; the slot a2 has both ends a21 and a22 opened at edges of the conductive plate a1; and the branch slot a3 has one end a31 coupled to the slot a2 and another end a32 extending along the slot a2, in a direction toward nearer one of the openings of the slot a2 when viewed from the one end a31 (in a direction toward the end a22), and shorted in the conductive plate a1.

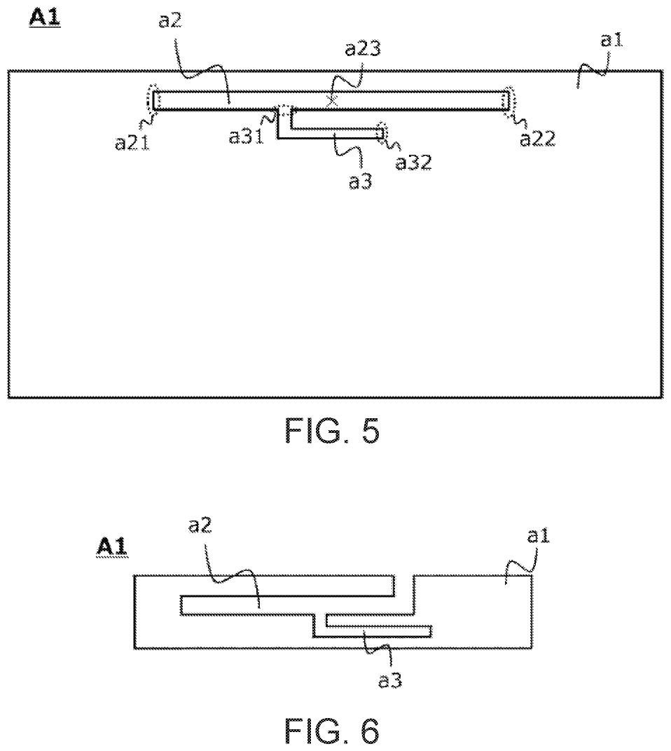

For example, as shown in FIG. 5, an antenna according to an aspect of the present disclosure may be an antenna A1 which is provided with a conductive plate a1, wherein: the conductive plate a1 is provided with a slot a2 and a branch slot a3; the slot a2 has both ends a21 and a22 shorted, respectively, in the conductive plate a1; and the branch slot a3 has one end a31 coupled to the slot a2 and another end a32 extending along the slot a2, in a direction toward a middle point a23 in the slot a2 when viewed from the end a31, and shorted in the conductive plate a1.

For example, as shown in FIG. 6, the conductive plate a1 may be formed by only a periphery part of the slot a2 and the branch slot a3.

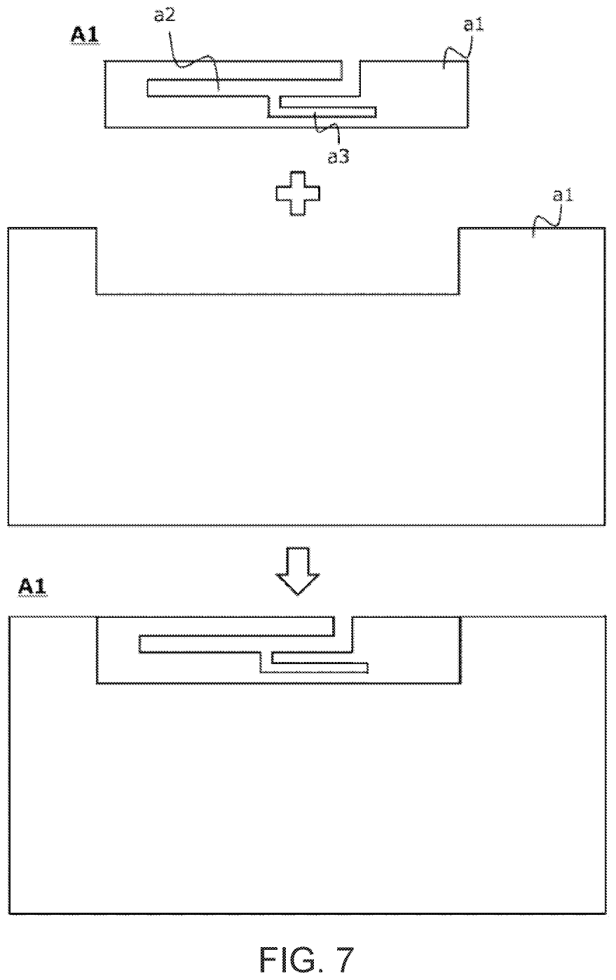

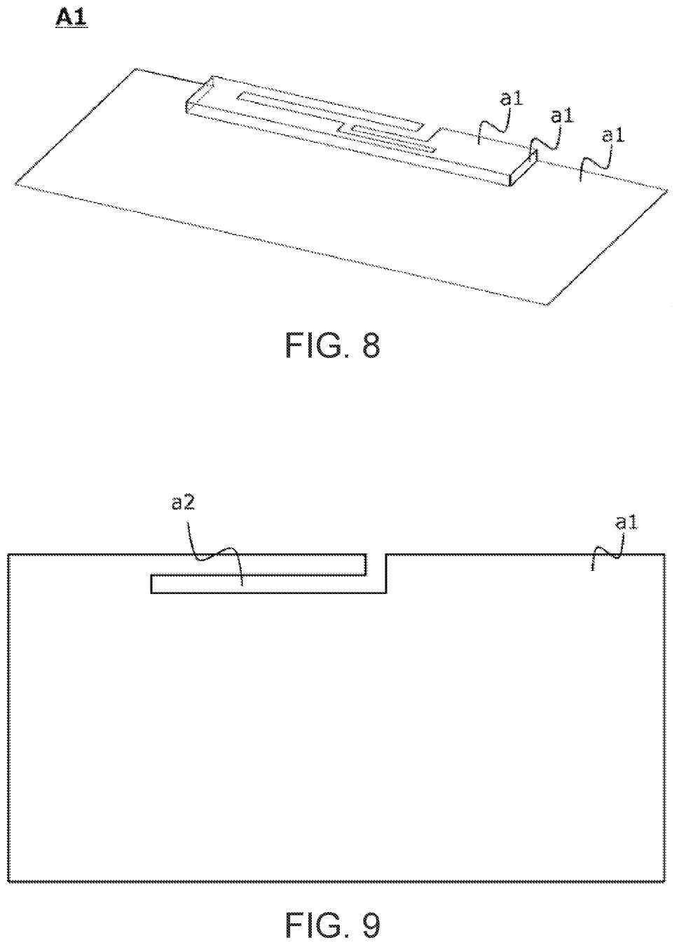

For example, as shown in FIG. 7 or 8, the conductive plate a1 may formed by coupling a periphery part of the slot a2 and the branch slot a3 to another part. Owing to the coupling, both parts may be formed in practically the same layer or may be formed in different layers as shown in FIG. 8.

The word of “slot” includes a concept of a shape that one of both ends thereof opens at an edge, a concept of a shape that the both ends thereof open at edges and a concept of a shape that the both ends thereof are not opened at the edges.

The “antinode of an electric field” represents the maximum point of electric field strength, and “a node of an electric field” represents the minimum point of the electric field strength.

For example, in the aspect according to each of FIGS. 1, 2 and 3, at the lowest-order (first) resonance frequency, the antinode of the electric field occurs in the end a22, and the node of the electric field occurs in the end a21.

Accordingly, in the aspect according to each of FIGS. 1, 2 and 3, the “direction toward an antinode of an electric field at the lowest-order resonance frequency of the antenna A1” is the “direction toward the end a22”.

For example, in the aspect according to FIG. 4, at the lowest-order (first) resonance frequency, the antinode of the electric field occur at each of the end a21 and the end a22, and the node of the electric field occurs at the middle point a23.

Accordingly, in the aspect according to FIG. 4, the “direction toward an antinode of an electric field at the lowest-order resonance frequency of the antenna A1” is the “direction toward nearer one of the openings of the slot a2 when viewed from the end a31 (in a direction toward the end a22)”.

For example, in the aspect according to FIG. 5, at the lowest-order (first) resonance frequency, the antinode of the electric field occurs at the middle point a23, and the node of the electric field occurs at each of the one end a21 and the other end a22. Accordingly, in the aspect according to FIG. 5, the “direction toward an antinode of an electric field at the lowest-order resonance frequency of the antenna A1” is the “direction toward the middle point a23”.

For example, each of FIGS. 9, 10 and 11 shows an antenna having no branch slot a3.

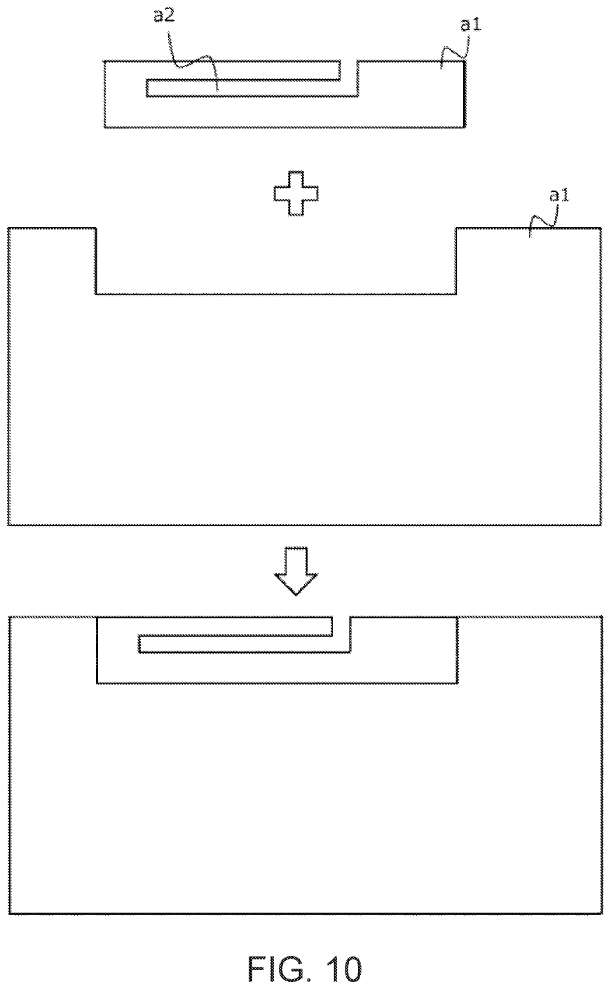

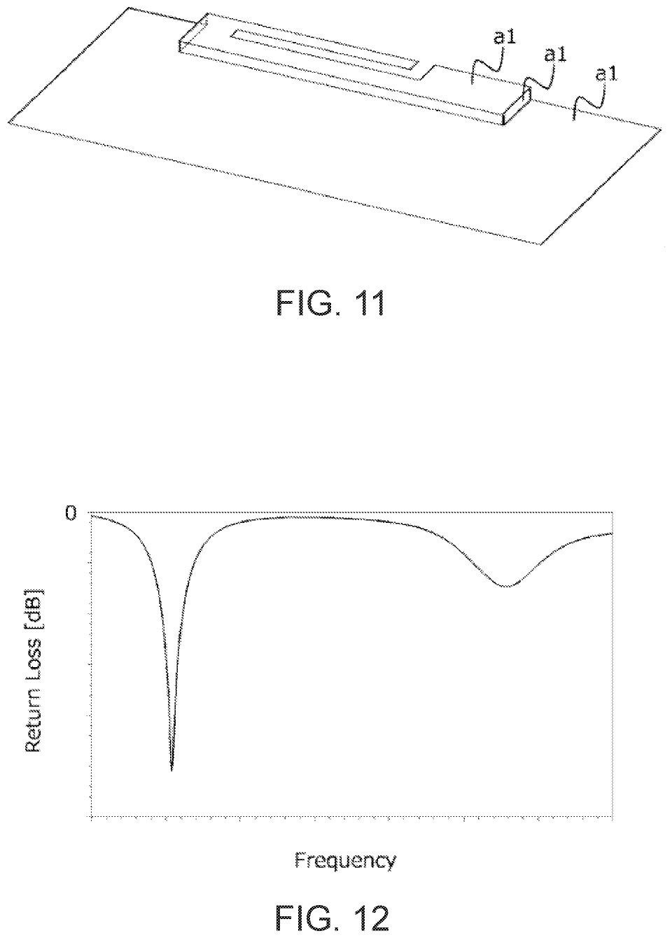

For example, in each of FIGS. 10 and 11, a conductive plate a1 is formed by coupling a periphery part of a slot a2 to a part other than the periphery part, wherein by the coupling, both parts may be formed in practically the same layer or may be formed in different layers as shown in FIG. 11.

For example, in the antenna of the aspect having no branch slot a3 as shown in each of FIGS. 9, 10 and 11, impedance is matched at each of a first resonance frequency and a third resonance frequency but is not matched at a second resonance frequency as shown in FIG. 12.

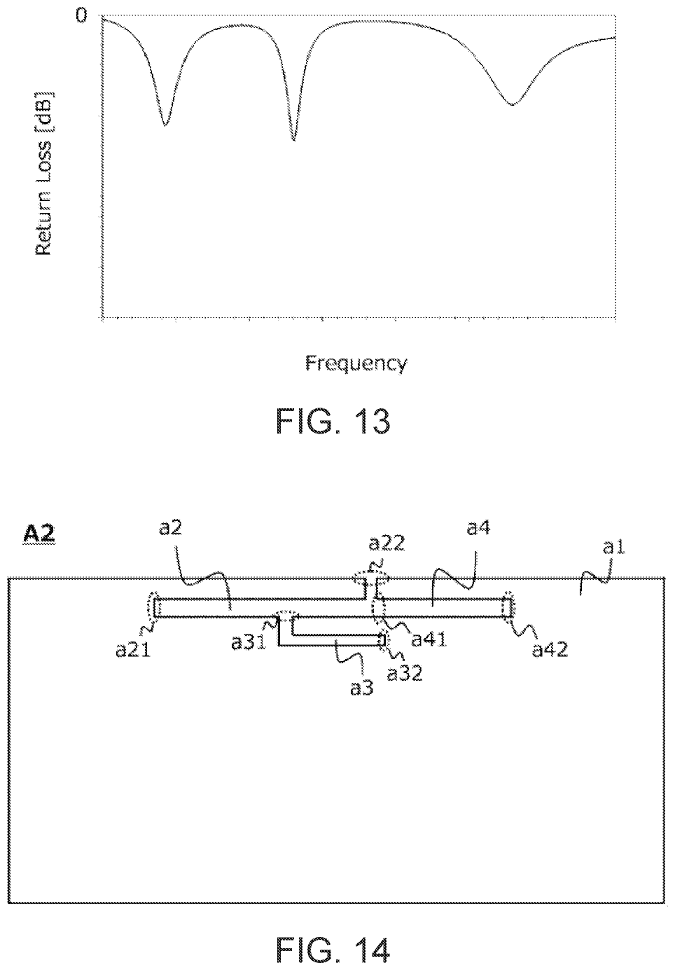

In contrast, in an antenna according to an aspect of the disclosure, impedance is matched at each of a first resonance frequency, a second resonance frequency and a third resonance frequency as shown in FIG. 13, for example.

In other words, according to an aspect of the present disclosure, a small antenna which can achieve impedance matching at a plurality of resonance frequencies can be provided, for example.

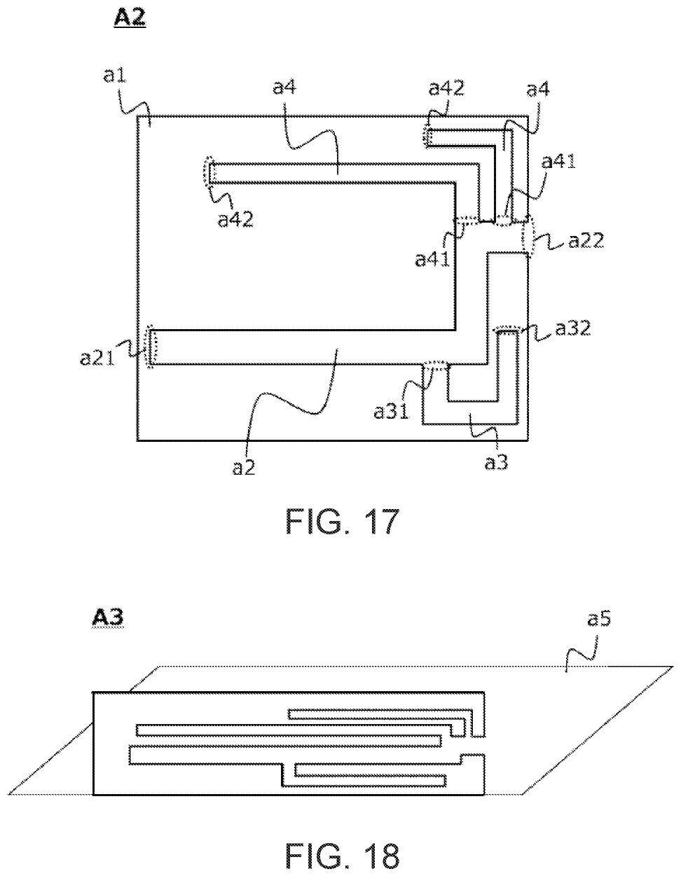

For example, as shown in each of FIGS. 14-17, an antenna according to an aspect of the present disclosure (e.g. the antenna A1 or a modified example thereof) may be an antenna A2, wherein: a conductive plate a1 is provided with a passive coupling slot a4; and the passive coupling slot a4 has one end a41 coupled to a slot a2 in proximity of an opening (in proximity of an end a22) and another end a42 shorted in the conductive plate a1.

For example, only one passive coupling slot a4 may be provided as shown in FIG. 14.

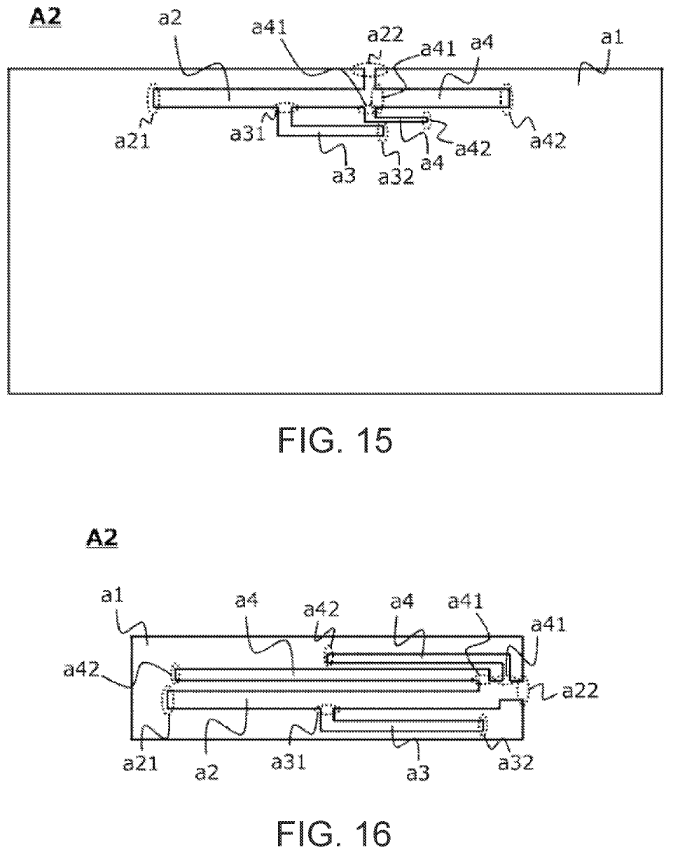

For example, a plurality of passive coupling slots a4 may be provided as shown in each of FIGS. 15-17.

For example, the passive coupling slot a4 contributes to radiation by indirectly feeding from feeding to the slot a2.

Thus, according to an aspect of the disclosure, a small antenna which operates at a wider frequency band can be provided, for example.

For example, an antenna according to an aspect of the present disclosure (e.g. an antenna A1 or A2, or a modified example thereof) may be an antenna A3, wherein: a conductive plate a1 is attached to an edge of substrate a5 so as to be practically perpendicular to the substrate a5; and an opening of a slot a2 in the conductive plate a1 is on a side, which is practically perpendicular to the substrate a5, of the conductive plate a1.

For example, the opening of the slot a2 in the conductive plate a1 may be on a side, which is practically parallel to the substrate a5, of the conductive plate a1.

For example, when the opening of the slot a2 in the conductive plate a1 is on the side practically perpendicular to the substrate a5, there is a case where characteristics of the antenna becomes better.

Thus, according to an aspect of the present disclosure, for example, a small antenna having better characteristics can be provided.

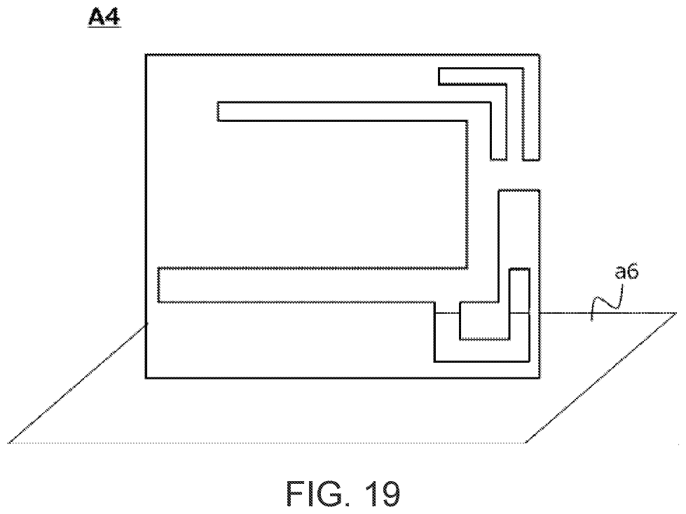

For example, as shown in FIG. 19, an antenna according to an aspect of the present disclosure (e.g. an antenna A1 or A2, or a modified example thereof) may be an antenna A4, wherein: a conductive plate a1 is formed so as to be practically perpendicular to a reflection plate a6; and an opening of a slot a2 in the conductive plate a1 is on a side, which is practically perpendicular to the reflection plate a6, of the conductive plate a1.

For example, the opening of the slot a2 in the conductive plate a1 may be on a side, which is practically parallel to the reflection plate a6, of the conductive plate a6.

For example, when the opening of the slot a2 in the conductive plate a1 is at the side practically perpendicular to the reflection plate a6, there is a case where characteristics of the antenna becomes better.

Thus, according to an aspect of the present disclosure, for example, a small antenna having better characteristics can be provided.

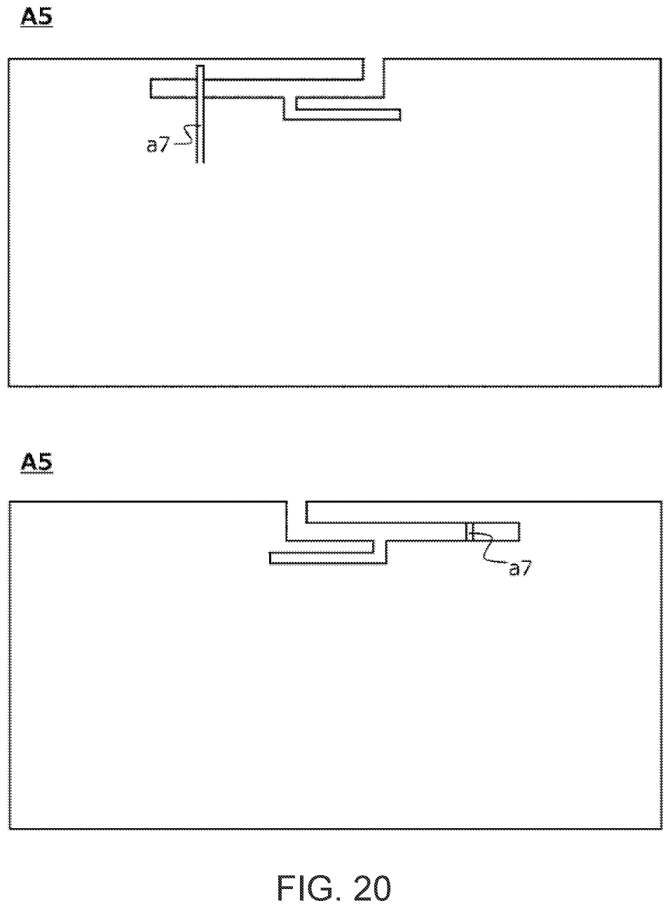

For example, as shown in each of FIGS. 20-22, an antenna according to an aspect of the present disclosure (e.g. an antenna A1, A2, A3 or A4, or a modified example thereof) may be an antenna A5, wherein: a region, which is adjacent to a first long side of a slot a2, of a conductive plate a1 is fed; and a region, which is adjacent to a second long side of the slot a2, of the conductive plate a1 is grounded.

Any one of long sides of the slot a2 may be the first long side or the second long side.

For example, as shown in FIG. 20, the antenna A5 may be fed by means of a feeding line a7 electrically connected to the region, which is adjacent to the first long side of the slot a2, of the conductive plate a1.

The words of “electrically connected” include both of a concept of electrical connection that conductors are directly connected to each other and a concept of electric connection of wireless feeding, such as EM feeding.

For example, the feeding line a7 may be provided in a layer other than the conductive plate a1 and may be connected to the conductive plate a1 though vias, etc.

For example, the feeding line a7 may be provided in a layer identical to a layer in which the conductive plate a1 is and may form a coplanar line by further extending along a clearance provided in the conductive plate a1.

For example, the feeding line a7 may be formed with an electrical wire such as a transmission line or by a metal plate.

For example, the conductive plate a1 and a metal plate part of the feeding line a7 may be formed by cutting out from a conductive plate using laser, etc.

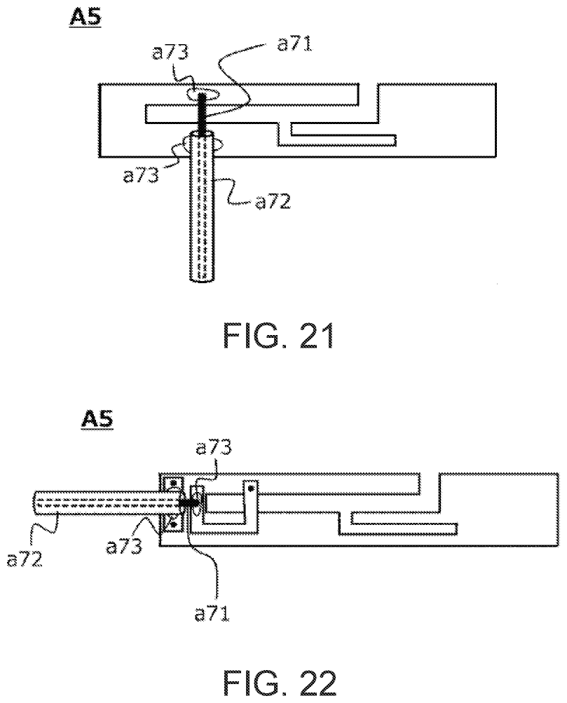

For example, the feeding line a7 may be formed with a coaxial cable as shown in each of FIGS. 21 and 22.

For example, a core wire a71 of the coaxial cable may be electrically connected to a region, which is adjacent to a first long side of a slot a2, of a conductive plate a1 by means of soldering, etc. as shown in FIG. 21, and a connecting aspect may use an auxiliary conductor and a via as shown in FIG. 22, for example.

For example, an outer conductor a72 of the coaxial cable may be electrically connected to the conductive plate a1 by means of soldering, etc. so that a region, which is adjacent to a second long side of the slot a2, of the conductive plate a1 as shown in FIG. 21, and a connecting aspect may use an auxiliary conductor and vias as shown in FIG. 22, for example.

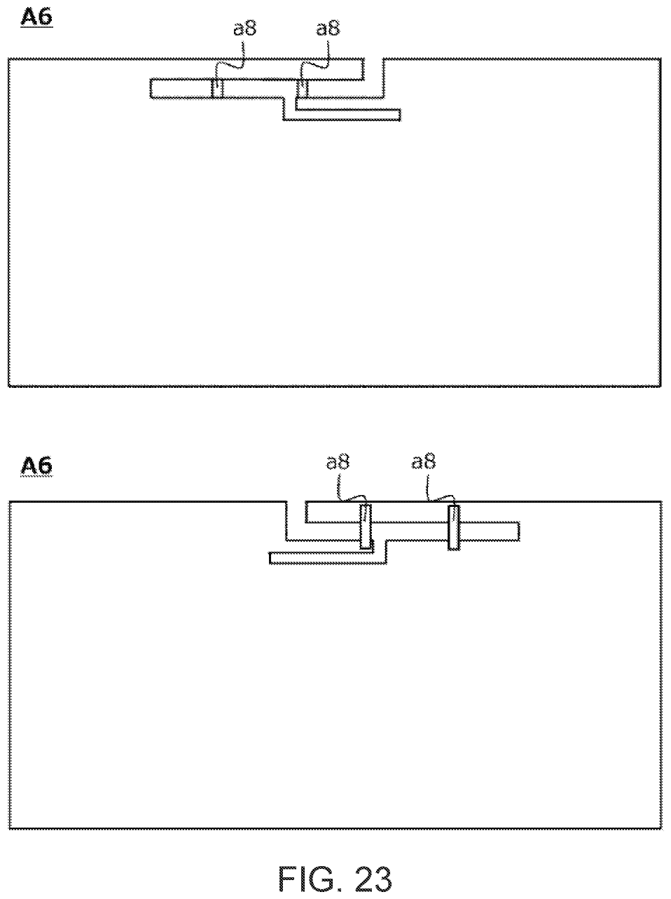

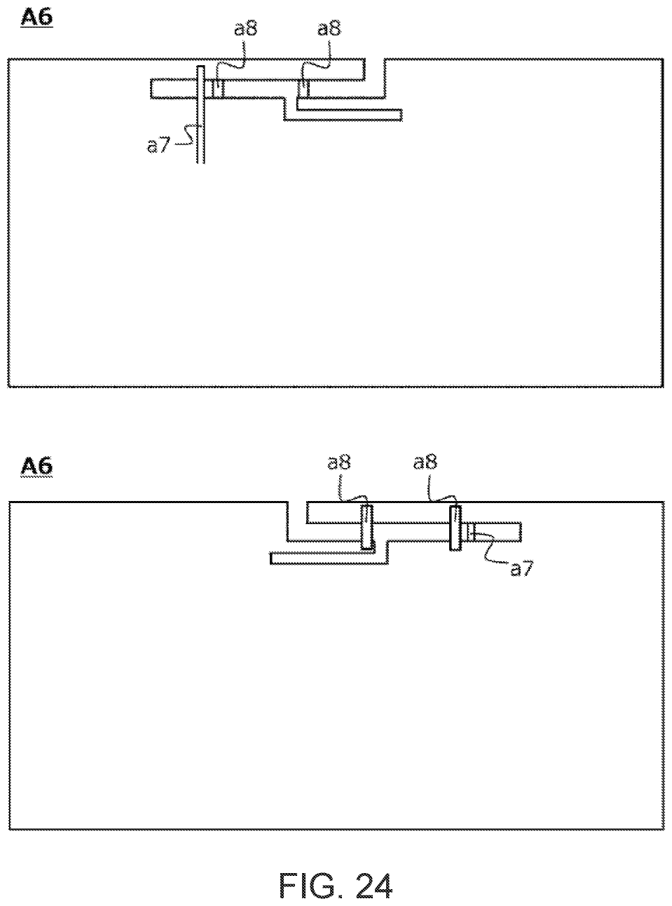

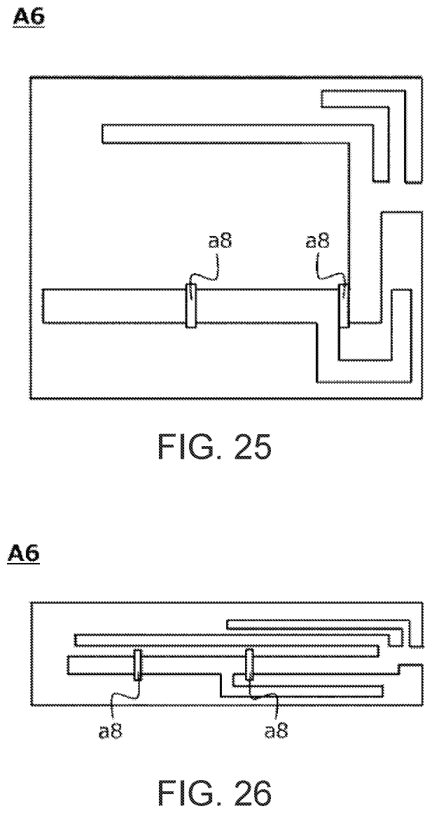

For example, as shown in each of FIGS. 23-26, an antenna according to an aspect of the present disclosure (e.g. an antenna A1, A2, A3, A4 or A5, or a modified example thereof) may be an antenna A6 which is provided with stubs a8 formed in a layer different from a layer including the conductive plate a1 so as to extend over a slot a2, wherein each of the stubs a8 has one end connected to a region, which is adjacent to a long side of a slot a2, of the conductive plate a1.

For example, the stub a8 may have another end which is not connected to the conductive plate a1.

For example, the stub a8 may be connected to the conductive plate a1 through a via, etc.

For example, one or two or more stubs a8 may be provided.

For example, the stub a8 may be made of a metal plate.

For example, the conductive plate a1 and the stubs a8 may be formed by cutting out from a conductive plate using laser etc.

For example, the feeding line a7 and the stubs a8 may be formed in the same layer or different layers.

Thus, according to an aspect of the present disclosure, for example, inductance can be reduced for a resonance frequency according to capacitance increased by the stubs a8.

In other words, according to an aspect of the present disclosure, a small antenna which can achieve impedance matching at a plurality of resonance frequencies can be provided, for example.

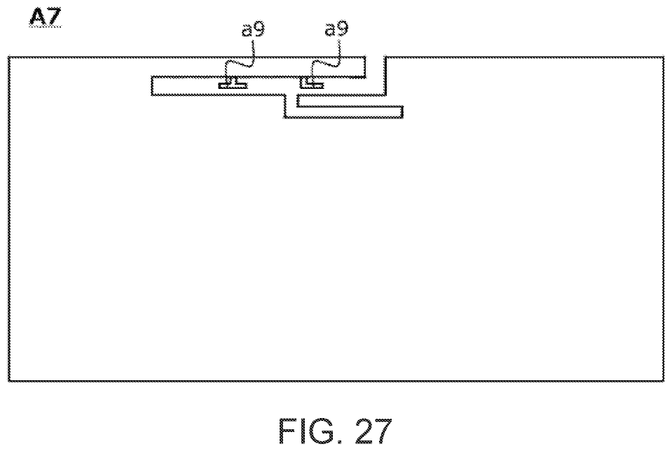

For example, as shown in FIG. 27, an antenna according to an aspect of the disclosure (e.g. an antenna A1, A2, A3, A4 or A5, or a modified example thereof) may be an antenna A7 which is provided with stabs a9 formed inside a slot a2 in the same layer as a layer including a conductive plate a1.

For example, another end of each of the stubs a9 may not be connected to a conductive plate a1.

For example, the other end of the stub a9 may be connected to the conductive plate a1.

For example, one or two or more stubs a9 may be provided.

For example, the stub a9 may have any shape, such as a straight line, a curved line, a bend line, etc.

For example, the stub a9 may has any shape, such as an L-shape, a T-shape, a meander shape, etc.

The words of meander shape include a concept represented by words of a zigzag shape, a comb tooth shape, a shape based on an interdigital structure, etc.

For example, the meander shape is formed by combining straight lines, curved lines, bent lines, etc.

For example, the stub a9 is made of a metal plate.

For example, the conductive plate a1 and the stabs a9 may be formed by cutting out from a conductive plate using laser etc.

Thus, according to an aspect of the present disclosure, for example, inductance can be reduced for a resonance frequency according to capacitance increased by the stubs a9.

In other words, according to an aspect of the present disclosure, a small antenna which can achieve impedance matching at a plurality of resonance frequencies can be provided, for example.

For example, a communication device according to an aspect of the present disclosure may be provided with an antenna according to an aspect of the present disclosure (an antenna A1, A2, A3, A4, A5, A6 or A7, or a modified example thereof).

Thus, according to an aspect of the present disclosure, for example, a communication device provided with a small antenna which can achieve impedance matching at a plurality of resonance frequencies can be provided.

Although the specific explanation about the present invention is made above referring to the embodiments, the present invention is not limited thereto. In the structure and details of the present invention, various modifications which can be understood by those skilled in the art are susceptible within the scope of the invention.

The present invention is based on Japanese Patent Application No. 2019-2527 filed on Jan. 10, 2019, and the contents of which are incorporated herein.

### REFERENCE SIGNS LIST

A1, A2, A3, A4, A5, A6, A7: antenna

a1: conductive plate

a2: slot

a3: branch slot

a4: passive coupling slot

a5: substrate

a6: reflection plate

a7: feeding line

a71 : core wire

a72: outer conductor

a73: solder

a8, a9: stub

1. An antenna comprising:
a conductive plate,
wherein:
the conductive plate comprises a slot and a branch slot;
one end of the branch slot is coupled to the slot; and
another end of the branch slot is closed in the conductive plate and extends along the slot in a direction toward an antinode of an electric field at a minimum order resonance frequency of the antenna when viewed from the one end.

2. An antenna comprising a conductive plate, wherein:
the conductive plate comprises a slot and a branch slot;
one end of the slot is closed in the conductive plate;
another end of the slot forms an opening at an edge of the conductive plate;
one end of the branch slot is coupled to the slot; and
another end of the branch slot extends along the slot, in a direction toward the other end of the slot when viewed from the one end of the branch slot, and is closed in the conductive plate.

3. An antenna comprising a conductive plate, wherein:
the conductive plate comprises a slot and a branch slot;
both ends of the slot form openings at edges of the conductive plate;
one end of the branch slot is coupled to the slot; and
another end of the branch slot extends along the slot, in a direction toward a nearer one of the openings of the slot when viewed from the one end, and is closed in the conductive plate.

4. The antenna as recited in claim 1, wherein:
the conductive plate comprises a passive coupling slot;
one end of the passive coupling slot is coupled to the slot in proximity to an opening of the slot; and
another end of the passive coupling slot is closed in the conductive plate.

5. The antenna as recited in claim 1, wherein:
the conductive plate is attached to an edge of a substrate so as to be practically perpendicular to the substrate; and
an opening of the slot in the conductive plate is on a side of the conductive plate, the side being practically perpendicular to the substrate.

6. The antenna as recited in claim 1, wherein:
the conductive plate is formed so as to be practically perpendicular to a reflection plate; and
an opening of the slot in the conductive plate is on a side of the conductive plate, the side being practically perpendicular to the reflection plate.

7. An antenna comprising a conductive plate, wherein:
the conductive plate comprises a slot and a branch slot;
both ends of the slot are closed in the conductive plate;
one end of the branch slot is coupled to the slot; and
another end of the branch slot extends along the slot, in a direction toward a middle point of the slot when viewed from the one end, and is closed in the conductive plate.

8. The antenna as recited in claim 1, wherein:
a region of the conductive plate is fed, the region being adjacent to a first long side of the slot; and
a region of the conductive plate is grounded, the region being adjacent to a second long side of the slot is grounded.

9. The antenna as recited in claim 1, wherein:
the antenna comprises a stub which is formed in a layer different from a layer including the conductive plate so as to extend over the slot; and
one end of the stub is connected to a region of the conductive plate, the region being adjacent to a long side of the slot.

10. The antenna as recited in claim 1, wherein:
the antenna comprises a stub which is formed inside the slot in a layer identical with a layer including the conductive plate;
one end of the stub is connected to a region of the conductive plate, the region being adjacent to a long side of the slot.

11. A communication device comprising the antenna as recited in claim 1.
